(19) United States
(12) Patent Application Publication
(10) Pub. No.: US 2018/0342945 A1
(43) Pub. Date: Nov. 29, 2018

(54) DISCHARGE DEVICE

(71) Applicant: Siemens Aktiengesellschaft, Munchen (DE)

(72) Inventors: Robert Lange, Crimmitschau (DE); Holger Strobelt, Stutzengrun (DE)

(73) Assignee: Siemens Aktiengesellschaft, Munchen (DE)

(21) Appl. No.: 15/990,148

(22) Filed: May 25, 2018

(30) Foreign Application Priority Data
May 26, 2017 (EP) 17172989.0

(51) Int. Cl. H02M 1/32; H02M 5/42; H01F 27/08; H01F 27/40

(52) U.S. Cl. CPC H02M 1/32; H02M 5/42; H02P 27/06; H01F 27/40; H01F 27/08

(57) ABSTRACT

A discharge device for discharging electrical energy from a circuit of an electrical converter includes an excitation device electrically connected to the circuit and producing during operation of the discharge device from the electrical energy of the circuit an alternating electromagnetic field, and an electrically conductive body constructed as a heatsink and receiving from the excitation device the alternating electromagnetic field so as to induce an eddy current in the electrically conductive body and converting the electrical energy generated in the electrically conductive body into thermal energy. Further disclosed is an electrical converter which includes the afore-described discharge device.

### CROSS-REFERENCES TO RELATED APPLICATIONS

This application claims the priority of European Patent Application, Serial No. 17172989.0, filed May 26, 2017, pursuant to 35 U.S.C. 119(a)-(d), the content of which is incorporated herein by reference in its entirety as if fully set forth herein.

### BACKGROUND OF THE INVENTION

The present invention relates to a discharge device for discharging electrical energy from a circuit of an electrical converter. The invention also relates to an electrical converter having the discharge device according to the invention.

The following discussion of related art is provided to assist the reader in understanding the advantages of the invention, and is not to be construed as an admission that this related art is prior art to this invention.

Resulting from their operation, electrical equipment and systems in the industrial environment often generate excess electrical energy which, from a technical viewpoint, is sometimes also unwelcome, requiring that an electrical component which absorbs or consumes the excess electrical energy is available precisely at the time the energy is generated. Electrical circuits affected in the electrical equipment and systems accordingly discharge their excess electrical energy into an electrical component of this type.

In particular in electrical drive systems, for instance for industrial plants or for electrically operable vehicles, which have an electrical converter and a frequently rotating electrical machine, braking operations generate electrical energy at electrical machines, which operate as generators in this situation, which electrical energy must be immediately consumed or stored in order to prevent the drive system being damaged or destroyed.

If the electrical drive system is being operated from an electrical network, for example, the excess electrical energy may be fed back into the electrical network, provided the electrical converter is actually designed for energy recovery. For cost reasons, however, electrical converters are often used that are incapable of energy recovery in this sense.

Electrical storage elements such as capacitors or rechargeable batteries, for example, can be provided here for receiving and storing the excess electrical energy. This does not always appear an attractive solution if economic aspects such as procurement costs or manufacturing costs combined with potentially high maintenance costs, for instance, are the main consideration when selecting such a solution. Since electrical storage elements employed in industry are normally expensive and high-maintenance, they are mostly used only when an energy management plan deems this to be efficient.

Another known solution also commonly employed is the use of an Ohmic resistor, also known as a braking resistor, to convert the excess electrical energy into thermal energy. Such braking resistors are extremely expensive, however, in particular for converting large amounts of electrical energy into thermal energy. In addition, braking resistors in the form of power resistors often take up a large amount of space in the electrical equipment or systems. Furthermore, the technology for implementing reliable heat dissipation from these braking resistors is relatively complex and expensive.

It is also known that, based on the principle of an eddy current brake, the excess electrical energy can also be used at least to assist a braking operation on linearly moving or rotating components, for instance the braking operation at the electrical machine. Using an eddy current brake, however, is only suitable when this solution is actually meant to be used to brake moving components. Moreover, this way of consuming excess electrical energy can be implemented only with relatively high mechanical complexity and also requires a large amount of space.

It would therefore be desirable and advantageous to obviate prior art shortcomings and to provide an improved discharge device for discharging electrical energy from a circuit, which device has an inexpensive, space-saving and simple technical design compared with the prior art.

### SUMMARY OF THE INVENTION

The invention is based on the knowledge that electrical equipment and systems, for instance electrical converters in electrical drive systems of industrial plants or of vehicles, can comprise in their circuits excess electrical energy which is produced as a result of operation and is generally unwanted, and which, even taking into account electrical losses, must be converted into thermal energy and carried away from the heat source. Existing solutions often require a technically complex implementation to do this, are usually expensive and mostly need a large amount of space.

According to one aspect of the present invention, a discharge device is proposed for discharging electrical energy from a circuit of an electrical converter, which discharge device includes an excitation device, which can be connected electrically to the circuit, and an electrically conductive body in the form of a heatsink, wherein the excitation device and the electrically conductive body interact such that during operation of the discharge device, the excitation device uses the electrical energy from the circuit to produce an alternating electromagnetic field, and wherein an eddy current is induced in the electrically conductive body by the alternating electromagnetic field such that the electrical energy generated in the electrically conductive body is converted into thermal energy.

During operation of the discharge device, the electrical energy, which, depending on the operating state, is available in excess in the circuit connected to the discharge device, is hence discharged. To do this, the excitation device produces from the excess electrical energy the alternating electromagnetic field, which advantageously induces by electrical induction the eddy current in the electrically conductive body, which advantageously is galvanically isolated from the circuit. The electrically conductive body is designed here to behave as an inductor.

The eddy current flowing through the electrically conductive body heats the electrically conductive body, which is mainly embodied as an Ohmic resistor. In the generation of the thermal energy of the electrically conductive body, the losses arising from magnetization reversal, i.e. hysteresis losses, of the electrical energy induced in the electrically conductive body actually account for up to ⅓ maximum of the total generated thermal energy in the electrically conductive body.

Particularly advantageously, the electrically conductive body is designed as a heatsink, which can not only receive but also transfer or dissipate the generated thermal energy. Thus the discharge device discharges the excess electrical energy from the circuit by inductive conversion of the electrical energy from the circuit into thermal energy in the electrically conductive body.

In a first advantageous embodiment of the discharge device according to the invention, the excitation device includes a field coil.

The alternating electromagnetic field that during operation of the discharge device generates the eddy current in the electrically conductive body can be produced by the field coil advantageously in a space-saving and low-cost manner. The alternating electric field could also be produced by a moving (rotating) permanent magnet, which must be made to move by the excess electrical energy from the circuit by relatively complex means.

In a further advantageous embodiment of the discharge device according to the invention, the excitation device includes a capacitor, which is electrically connected to the field coil and forms a resonant circuit with the field coil:

By means of the resonant circuit formed by field coil and capacitor, the excess electrical energy emitted by the circuit is exchanged cyclically between the electrical field of the capacitor and the magnetic field of the field coil. Depending on the design of the field coil and of the capacitor, the alternating electromagnetic field can be designed to resonate at a high frequency. The magnitude and direction of an alternating electromagnetic field resonating at high frequency changes rapidly and continuously, which is advantageously suitable for rapid and efficient transfer of the electrical energy from the field coil into the electrically conductive body.

In a further advantageous embodiment of the discharge device according to the invention, the excitation device includes a first switchable power semiconductor as a switching device, and the first switchable power semiconductor is electrically connected to the field coil.

During operation of the discharge device, the switchable power semiconductor can be used advantageously to adjust the amount of energy of the electrical energy induced in the electrically conductive body via the field coil and/or the frequency of the alternating electromagnetic field in the field coil.

In a further advantageous embodiment of the discharge device according to the invention, the excitation device includes a second switchable power semiconductor of the switching device, which power semiconductor is connected to the first switchable power semiconductor, and both switchable power semiconductors form an electrical arm of an electrical bridge circuit.

During operation of the discharge device, by means of the switchable power semiconductors arranged as an arm in the electrical bridge circuit it is possible to improve adjustment of the amount of energy of the electrical energy induced in the electrically conductive body via the field coil and/or of the frequency of the alternating electromagnetic field in the field coil compared with solely using the first switchable power semiconductor.

In a further advantageous embodiment of the discharge device according to the invention, the excitation device includes a control unit, which is used during operation of the discharge device to switch the first switchable power semiconductor and, if present, the second power semiconductor.

For this purpose, the control unit includes in particular a processing unit, which uses a control technique such as pulse width modulation to generate switching signals for controlling the switchable power semiconductor(s). During operation of the discharge device, this improves in a particularly advantageous manner the means of adjusting the amount of energy of the electrical energy induced in the electrically conductive body via the field coil and/or the frequency of the alternating electromagnetic field in the field coil.

In a further advantageous embodiment of the discharge device according to the invention, the field coil is a radiofrequency coil, which is designed such that during operation of the discharge device, an excitation current flows through the radiofrequency coil at a frequency of 20 kHz to 50 kHz.

This radiofrequency coil, which is particularly suitable for a high-frequency current flow of the excitation current, provides particularly advantageously the alternating electromagnetic field, which is provided as a high-frequency alternating electromagnetic field for rapid and efficient transfer of the electrical energy from the field coil into the electrically conductive body.

In a further advantageous embodiment of the discharge device according to the invention, the electrically conductive body is formed from a single part or from multiple parts, wherein the electrically conductive body formed from multiple parts includes a material inlay made of ferromagnetic material.

When the electrically conductive body is formed from a single part, an inexpensive solution that is simple to produce can be achieved by using just one material, which in particular must have magnetizable properties in addition to metallic properties. The better the magnetic properties of the material, for instance those of iron or iron compounds, the greater the thermal energy that can be converted from the electrical energy induced in the electrically conductive body, which advantageously improves the discharge of the electrical energy from the circuit.

If the electrically conductive body is made from multiple parts, the material inlay made of ferromagnetic material can focus the eddy currents, and hence the generated thermal energy, at a preferred location in the electrically conductive body, with other parts of the electrically conductive body then being able to comprise material that can be magnetized only slightly or not at all, for instance paramagnetic aluminum.

In a further advantageous embodiment of the discharge device according to the invention, the electrically conductive body includes cooling fins. Cooling fins are particularly suitable here for dissipating the thermal energy, which is converted from the induced electrical energy in the electrically conductive heatsink and received by the electrically conductive heatsink, to a liquid or gaseous medium surrounding the electrically conductive heatsink.

In a further advantageous embodiment of the discharge device according to the invention, the electrically conductive body is at least part of a housing for the electrical converter, and/or the electrically conductive body is at least part of an external component outside the electrical converter.

The housing, such as the housing of an electrical converter, generally offers a capacity that is larger than conventional heatsinks of such electrical converters, and in particular a capacity that is inherently present in the system, for receiving the thermal energy generated by induction of electrical energy into the housing during operation of the discharge device. In particular, the outward-facing surface of the housing is also advantageously suited to dissipating the thermal energy received by the housing.

In addition, the electrically conductive body as an external component outside the electrical converter can be formed at least as part of a control cabinet, in particular as part of a control cabinet wall. In this case, the electrical energy is induced in the control cabinet wall for example, where it is converted into thermal energy and dissipated from the heat source.

In a further advantageous embodiment of the discharge device according to the invention, some or all of the electrically conductive body consists of an electrically conductive plastic.

Plastics can also be in the form of a composite material, for instance, that has electrically conductive and also magnetic properties. Such plastics are likewise intended, after induction of the electrical energy in the electrically conductive plastic and the conversion into thermal energy, to receive and dissipate the heat generated thereby. Plastics usually have the advantage over other electrically conductive materials that they have a lower weight for comparably identical stability.

In a further advantageous embodiment of the discharge device according to the invention, an electrically insulating and/or thermally insulating separator is provided immediately between the electrically conductive body and the field coil of the excitation device.

The separator, which is for example an electrical insulator, can be embodied as a housing for the electrical converter, with the electrically conductive body then being part of the control cabinet wall, for example as an external component. As a result, the electrical energy is induced not in the housing of the electrical converter but almost entirely in the control cabinet wall, where it is converted into thermal energy and dissipated. In this case, the electrically insulating housing protects the interior of the electrical converter from dirt and moisture, for example.

According to another aspect of the invention, an electrical converter includes a circuit, and a discharge device having an excitation device electrically connected to the circuit and producing during operation of the discharge device from the electrical energy of the circuit an alternating electromagnetic field, and an electrically conductive body constructed as a heatsink and receiving from the excitation device the alternating electromagnetic field so as to induce an eddy current in the electrically conductive body and converting the electrical energy generated in the electrically conductive body into thermal energy.

The electrical converter can have, for instance in the event of an emergency shutdown, an operating state that requires rapid and reliable discharge of the electrical energy at least from one of its circuits. This can become necessary in particular when the electrical converter still has excess electrical energy at the circuit even after the emergency shutdown, or continues to be supplied with then excess electrical energy from outside via its electrical connections. The circuit can be discharged by the discharge device according to the invention until the electrical energy has fallen to a level that is safe for people and electrical equipment and components.

In an advantageous embodiment of the converter according to the invention, the circuit is in the form of a DC-link circuit.

In a further advantageous embodiment of the converter according to the invention, the converter is embodied as a frequency converter comprising a rectifier which is incapable of energy recovery, which can be connected on its input side to a first electrical network and is connected on its output side to a DC-link circuit, and comprising an inverter which is capable of energy recovery, which is connected on its input side to the DC-link circuit and can be connected on its output side to a second electrical network or an electrical machine.

In particular, the discharge device is particularly advantageously suitable for a frequency converter that although it uses the first electrical network during operation to supply the electrical machine or the second electrical network with electrical energy, is unable to feed back into the first electrical network electrical energy produced, for example, by the electrical machine acting as a generator, because its rectifier is incapable of energy recovery.

During operation, the inverter, which is capable of energy recovery, can feed back into the DC-link circuit, for example, the electrical energy produced by the electrical machine acting as a generator. The discharge device provides at the circuit a discharge of the excess electrical energy, which then cannot be transferred into the first electrical network by the rectifier, which is incapable of energy recovery.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a first schematic diagram of the discharge device according to the invention;

FIG. 2 shows a second schematic diagram of the discharge device according to the invention shown in FIG. 1 comprising an electrical converter;

FIG. 3 shows a third schematic diagram of the discharge device according to the invention shown in FIG. 1 comprising the electrical converter shown in FIG. 2; and

FIG. 4 shows a fourth schematic diagram of the discharge device according to the invention shown in FIG. 1 incorporating the electrical converter shown in FIG. 2 or FIG. 3.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

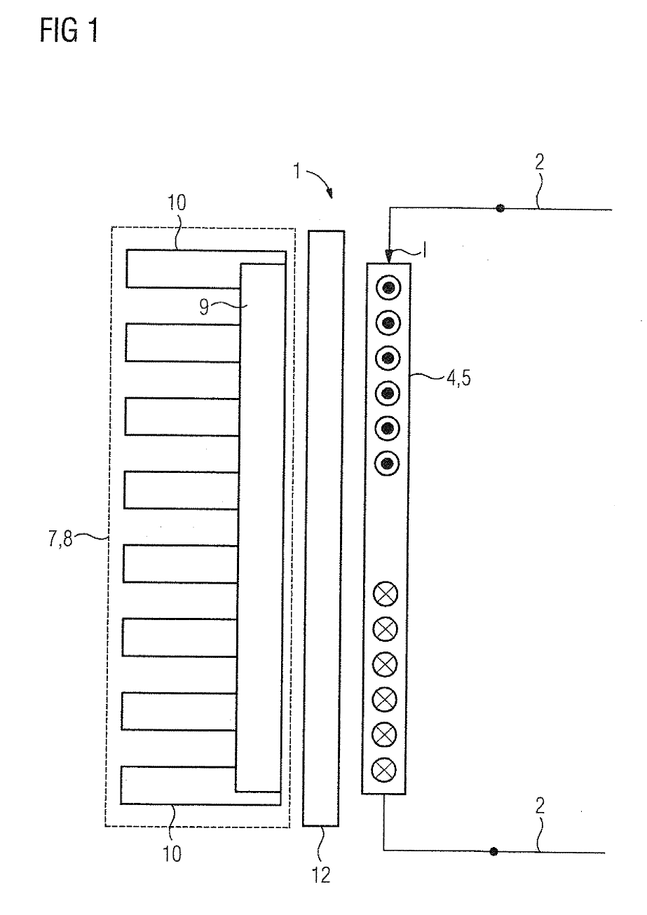

Turning now to the drawing, and in particular to FIG. 1, there is shown a first schematic diagram of the discharge device 1 according to the invention. A circuit 2 is electrically connected to a field coil 4 of an excitation device 5 of the discharge device 1. During operation of the discharge device 1, the circuit 2 has excess electrical energy, from which an alternating electromagnetic field is produced in the field coil 4 by means of an excitation current I, in particular by means of a high-frequency excitation current I.

This alternating electromagnetic field in turn generates by means of electrical induction an eddy current in an electrically conductive body 7, advantageously in the exemplary embodiment of FIG. 1 in a material inlay 9 of the electrically conductive body 7, which material inlay comprises ferromagnetic material. This eddy current causes the induced electrical energy to be converted into thermal energy in the electrically conductive body 7 or in the material inlay 9.

The electrically conductive body 7 of the discharge device 1 is embodied as a heatsink 8, and in FIG. 1 comprises cooling fins 10. During operation of the discharge device 1, the electrically conductive body 7 embodied as the heatsink 8 cannot only receive thermal energy produced from induced electrical energy but also dissipate said thermal energy to an in general gaseous or liquid surrounding medium.

In the application example of FIG. 1, an electrically insulating and thermally insulating separator 12 is arranged immediately between the field coil 4 and the electrically conductive body 7. During the electrical induction, no electrical energy is induced in this separator 12 because of its insulating property. Since in the application example the separator 12 also has thermal insulation properties, additional heating, for instance of the excitation device 5, in particular here of its field coil 4, by the thermal energy produced in the electrically conductive body 7 is largely prevented.

Furthermore, the separator 12 is also advantageously suitable as an enclosure, for instance in order to protect the excitation device 5 from dirt and moisture.

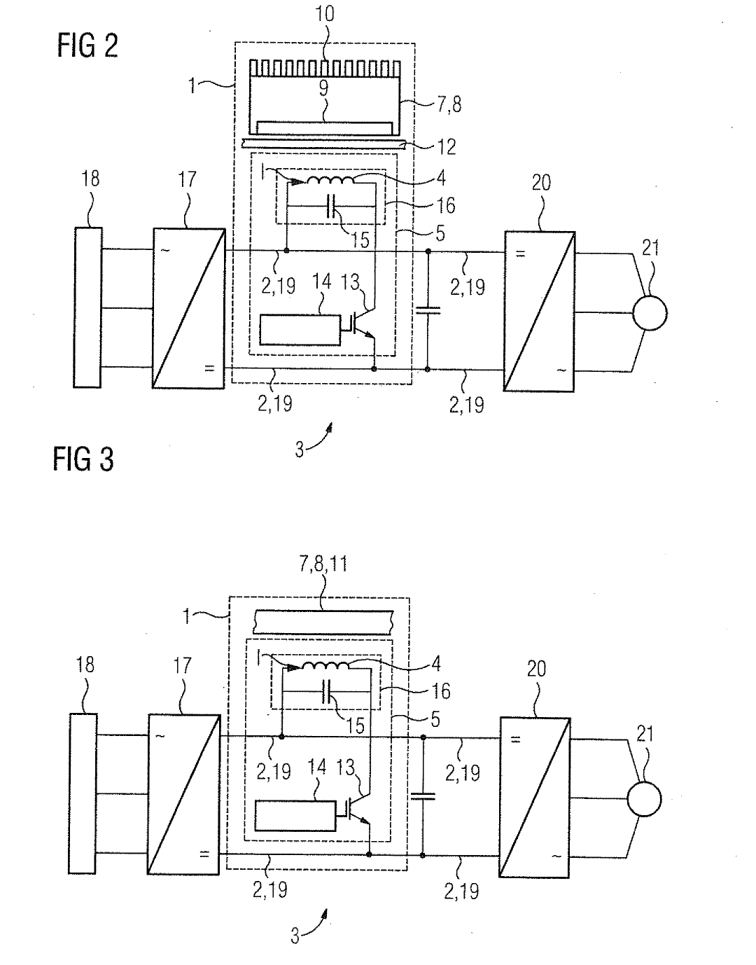

FIG. 2 shows a second schematic diagram of the discharge device 1 according to the invention shown in FIG. 1 comprising an electrical converter 3.

The electrical converter 3 is embodied as a frequency converter, for example, and comprises a rectifier 17 which is incapable of energy recovery, which is connected on its input side to a first electrical network 18 and is connected on its output side to a DC-link circuit 19 as the circuit 2. The electrical converter 3 also comprises an inverter 20 which is capable of energy recovery, which is connected on its input side to the DC-link circuit 19 as the circuit 2 and is connected on its output side to an electrical machine 21.

The field coil 4 and a capacitor 15, which by connecting electrically in parallel jointly form a resonant circuit 16, are electrically connected on one side to a first phase of the DC-link circuit 19 and on the other side are electrically connected to a first switchable power semiconductor 13. In addition, the first switchable power semiconductor 13 is electrically connected to a second phase of the DC-link circuit 19.

A control unit 14 controls during operation of the discharge device 1 the first switchable power semiconductor 13 as a switching device.

The control unit 14 can comprise a processing unit (not shown in FIG. 2), which uses a control technique such as pulse width modulation to generate switching signals for controlling the first switchable power semiconductor 13.

In FIG. 2, the resonant circuit 16, which comprises the field coil 4 and the capacitor 15, forms with the first switchable power semiconductor 13 and the control unit 14 the excitation device 5.

During operation of the discharge device 1, the circuit 2 then has excess electrical energy, from which the alternating electromagnetic field is produced in the field coil 4 by the excitation current I.

The alternating electromagnetic field in turn generates by means of electrical induction the eddy current in the electrically conductive body 7, in the exemplary embodiment of FIG. 1 and FIG. 2 advantageously in the material inlay 9 of the electrically conductive body 7, which material inlay comprises ferromagnetic material. The eddy current causes the induced electrical energy to be converted into thermal energy in the electrically conductive body 7 or in the material inlay 9.

As in FIG. 1, the electrically conductive body 7 of the discharge device 1 in FIG. 2 is likewise embodied as a heatsink 8 and comprises cooling fins 10.

Similar to the application example of FIG. 1, in FIG. 2 by way of example the electrically insulating and thermally insulating separator 12 is arranged immediately between the field coil 4 and the electrically conductive body 7. During the electrical induction, no electrical energy is induced in this separator 12 because of its insulating property. Since the separator 12 in the application example of FIG. 1 can likewise have thermal insulation properties, the additional heating of the excitation device 5, in particular here of the field coil 4, by the thermal energy produced in the electrically conductive body 7 is then largely prevented.

In FIG. 2, as shown in FIG. 1, it is again the case that the separator 12 is advantageously suitable as an enclosure, for instance in order to protect the excitation device 5 from dirt and moisture.

FIG. 3 shows a third schematic diagram of the discharge device 1 according to the invention shown in FIG. 1 comprising the electrical converter shown in FIG. 2.

Unlike FIG. 2, FIG. 3 discloses that during operation of the discharge device 1, the excess electrical energy of the DC-link circuit 19 as the circuit 2 is induced by means of the excitation device 5 in the electrically conductive body 7 embodied as a housing 11 or as part of a housing 11 of the electrical converter 3. The housing 11 as the electrically conductive body 7 is in the form of a heatsink 8 in the application example shown in FIG. 3.

Unlike FIG. 1 and FIG. 2, in FIG. 3 there is no electrically insulating and/or thermally insulating separator 12 provided between the field coil 4 of the excitation device 5 and the electrically conductive body 7. In this case, the housing 11 of the electrical converter 3 can protect the electrical converter 3 from dirt and moisture.

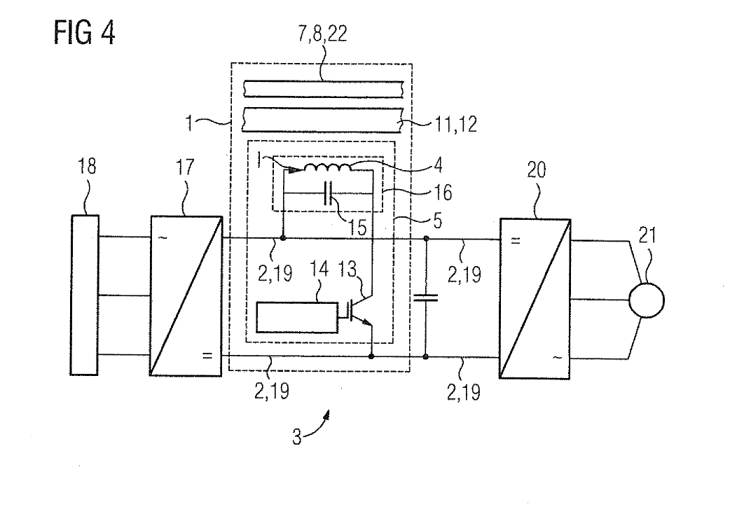

FIG. 4 shows a fourth schematic diagram of the discharge device 1 according to the invention shown in FIG. 1 comprising the electrical converter shown in FIG. 2 or FIG. 3.

Unlike FIG. 2 and FIG. 3, FIG. 4 discloses that during operation of the discharge device 1, the excess electrical energy of the DC-link circuit 19 as the circuit 2 is induced by means of the excitation device 5 in the electrically conductive body 7 embodied as an external component 22 or as part of an external component 22 outside the electrical converter 3. The external component 22 as the electrically conductive body 7 is in the form of a heatsink 8 in the application example of FIG. 4.

For example, a control cabinet wall of a control cabinet can be provided as the external component 22, in which the excess electrical energy of the DC-link circuit 19 is induced, converted into thermal energy and dissipated, for example, to the gaseous or liquid surrounding medium.

A housing 11 of the electrical converter 3 is in this case embodied as an electrically insulating and/or thermally insulating separator 12. In this case it can protect the electrical converter 3 from dirt and moisture and prevent thermal energy produced in the external component 22 from encroaching into the electrical converter 3.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A discharge device for discharging electrical energy from a circuit of an electrical converter, the discharge device comprising:
an excitation device electrically connected to the circuit and producing during operation of the discharge device from the electrical energy of the circuit an alternating electromagnetic field, and
an electrically conductive body constructed as a heatsink and receiving from the excitation device the alternating electromagnetic field so as to induce an eddy current in the electrically conductive body and converting the electrical energy generated in the electrically conductive body into thermal energy

2. The discharge device of claim 1, wherein the excitation device comprises a field coil.

3. The discharge device of claim 2, wherein the excitation device comprises a capacitor, which is electrically connected to the field coil and forms a resonant circuit with the field coil.

4. The discharge device of claim 2, wherein the excitation device comprises a first switchable power semiconductor as a switching device, with the first switchable power semiconductor being electrically connected to the field coil.

5. The discharge device of claim 4, wherein the excitation device comprises a second switchable power semiconductor connected to the first switchable power semiconductor, with both switchable power semiconductors forming an electrical arm of an electrical bridge circuit.

6. The discharge device of claim 4, wherein the excitation device comprises a control unit, which switches, during operation the discharge device, the first switchable power semiconductor.

7. The discharge device of claim 5, wherein the excitation device comprises a control unit, which switches, during operation of the discharge device, the first switchable power semiconductor and the second switchable power semiconductor.

8. The discharge device of claim 2, wherein the field coil is a radiofrequency coil, which is designed such that during operation of the discharge device, an excitation current having a frequency of 20 kHz to 50 kHz flows through the radiofrequency coil.

9. The discharge device of claim 1, wherein the electrically conductive body is formed from a single part.

10. The discharge device of claim 1, wherein the electrically conductive body is formed from multiple parts, and comprises a material inlay made of ferromagnetic material.

11. The discharge device of claim 1, wherein the electrically conductive body comprises cooling fins.

12. The discharge device of claim 1, wherein the electrically conductive body forms at least part of a housing for the electrical converter.

13. The discharge device of claim 1, wherein the electrically conductive body forms at least part of an external component disposed outside the electrical converter.

14. The discharge device of claim 1, wherein some or all of the electrically conductive body consists of an electrically conductive plastic.

15. The discharge device of claim 2, further comprising an electrically insulating or thermally insulating separator arranged immediately between the electrically conductive body and the field coil.

16. An electrical converter comprising:
a circuit, and
a discharge device comprising an excitation device electrically connected to the circuit and producing during operation of the discharge device from the electrical energy of the circuit an alternating electromagnetic field, and an electrically conductive body constructed as a heatsink and receiving from the excitation device the alternating electromagnetic field so as to induce an eddy current in the electrically conductive body and converting the electrical energy generated in the electrically conductive body into thermal energy.

17. The electrical converter of claim 16, wherein the circuit is a DC-link circuit.

18. The electrical converter of claim 16, wherein the electrical converter is embodied as a frequency converter and comprises
a rectifier having input side connected to a first electrical network and output side connected to the DC-link circuit, with the rectifier being incapable of energy recovery, and
an inverter having an input side connected to the DC-link circuit and an output side connected to a second electrical network or to an electrical machine, with the rectifier being capable of energy recovery.
